(19) United States
(12) Patent Application Publication
(10) Pub. No.: US 2023/0142662 A1
(43) Pub. Date: May 11, 2023

(54) CHEMICAL SOLUTION PROPORTIONING METHOD

(71) Applicant: Timothy Sherwood Aselton, II, Tallahassee, FL (US)

(72) Inventor: Timothy Sherwood Aselton, II, Tallahassee, FL (US)

(21) Appl. No.: 18/092,254

(22) Filed: Dec. 31, 2022

Related U.S. Application Data
(63) Continuation of application No. 15/185,012, filed on Jun. 16, 2016, now abandoned.
(60) Provisional application No. 62/180,178, filed on Jun. 16, 2015.

(51) Int. Cl. B01F 35/71; B08B 3/08; B08B 3/10; F16K 5/06; B08B 3/02; F16K 15/18; B01F 33/84

(52) U.S. Cl. CPC B01F 35/714; B08B 3/08; B08B 3/10; F16K 5/0605; B08B 3/026; F16K 15/1826; F16K 15/1848; B01F 33/84; B01F 35/718051; B08B 2203/0223; B08B 3/02; B08B 2203/0217; B01F 2101/24

(57) ABSTRACT

The steps of providing a cleaning device, a liquid proportioning device and a series of tanks filled with liquids. The cleaning device has a nozzle, a series of hoses and a pump. The liquid proportioning device includes a series of passageways, having three chambers and two valves, and a manifold for mixing the liquids to form a cleaning solution. The passageways include knobs to set the ratio of each liquid that the user desires to mix into a cleaning solution. Once the cleaning solution is mixed, it is fed through a pump to cleaning device for use. The proportioning device allows a user to easily, quickly and accurately mix liquids to form a cleaning solution.

### BACKGROUND OF THE INVENTION

This non-provisional patent application is a Continuation of non-provisional patent application Ser. No. 15/185,012 filed Jun. 16, 2016, which is based on provisional patent application Ser. No. 62/180,178 filed Jun. 16, 2015.

### FIELD OF THE INVENTION

This invention relates to a system and method of combining solutions of liquid. More specifically, the invention comprises a method of proportioning and combining chemical solutions for use in hydro-cleaning.

### DESCRIPTION OF THE RELATED ART

Hydro-cleaning describes the use of water propelled at relatively high speeds in order to clean surfaces and materials. Pressure washing or power washing refers to the process of using a high-pressure sprayer to remove dirt, mud, grime, mold or loose paint from the surface of buildings, decks, concrete or other surfaces or objects. A pressure washer device sprays a mixture of liquid at a high velocity onto the desired surface. Typically, a large volume of mixture or solution is needed to adequately wash an area.

Water alone is used for many cleaning applications, typically in high pressure power washing or pressure washing. However, water in combination with special chemicals is desirable to aid in cleaning certain surfaces or objects. This is often the case for professional hydro-cleaning services. The use of chemicals mixed with water is especially applicable in the case of “soft washing.” Soft washing combines certain chemicals with water in order to clean surfaces or materials which cannot be exposed to such high pressures as those used with power washing such as house siding, roofing, etc. Soft washing is performed at much lower pressures than power washing and pressure washing, thereby typically requiring a chemical mixture to perform the cleaning. A chemical mixture or solution must be pre-mixed before it is used to hydro-clean a surface. Therefore, a professional hydro-cleaner typically arrives at a site, spends time mixing the solution and then washes the area or surface to be cleaned. An accurate proportion of chemicals is important, therefore if the user fails to add the correct proportion or runs out of a chemical on-site, the user stands to lose valuable time and resources. Additionally, it is often difficult for a user to mix the solution accurately. An inaccurate mixture may result in less than desirable soft washing results. Further, the user may mix too much solution, which may require the user to discard the solution upon finishing the washing.

It would be beneficial to have a method to prepare solutions on-site, proportioning the chemicals accurately and mixing the solution concurrently with the hydro-cleaning itself. The method should allow multiple liquids to be mixed accurately at any given ratio using suction.

Therefore, what is needed is a method which allows a user to attach a proportioning device to a series of tanks containing liquids, mix a solution of pre-set ratios of liquids and use the solution to hydro-clean a surface or object. The present invention achieves this objective, as well as others that are explained in the following description.

### SUMMARY OF THE INVENTION

The present method comprises the steps of providing a cleaning device, a liquid proportioning device and a series of tanks filled with liquids. The cleaning device has a nozzle, a series of hoses and a pump. The liquid proportioning device is upstream of the cleaning device and includes a series of passageways, having three chambers and two valves, and a manifold for mixing the liquids to form a cleaning solution. The passageways include knobs to set the ratio of each liquid that the user desires to mix into a cleaning solution. Once the cleaning solution is mixed, it flows downstream through a single hose and through a pump and out of the nozzle of the cleaning device for use. The proportioning device allows a user to easily, quickly and accurately mix liquids in desired proportions to form a cleaning solution. The method reduces wasteful by-product and saves time.

### BRIEF DESCRIPTION OF THE DRAWINGS

For a fuller understanding of the nature of the present invention, reference should be had to the following detailed description taken in connection with the accompanying drawings in which:

FIG. 1 is a perspective view, showing the liquid solution proportioning system of the present invention;

FIG. 2 is a schematic view, showing the proportioning device of the present invention;

FIG. 3 is a perspective view, showing another embodiment of the proportioning device;

FIG. 4 is a cut-away view, showing a multi-chambered passageway of the present proportioning device;

FIG. 5 is a cut-away view, showing another alternative for a valve used in the present proportioning device;

FIG. 6 is a cut-away view, showing an alternative valve used in the proportioning device of the present invention; and

FIG. 7 is a cut-away view, showing another alternative for a valve used in the present proportioning device.

Like reference numerals refer to like parts throughout the several views of the drawings.

### REFERENCE NUMERALS IN THE DRAWINGS

12 pump
16 liquid jet
20 nozzle
22 proportioning device
24 hose
28 manifold
30 cap
32 first chamber
34 second chamber
36 knob
40 second valve
42 first valve
44 third chamber
46 stem
48 sphere
50 passageway
52 tanks
60 valve opening
64 component
66 hose connecting pump to nozzle

### DETAILED DESCRIPTION OF THE PREFERRED EMBODIMENTS

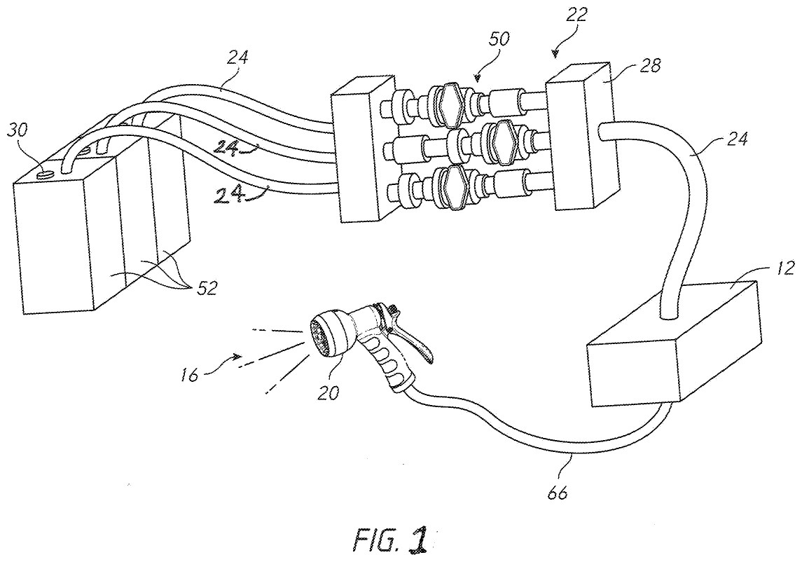

The present proportioning system provides an efficient, accurate method of mixing a solution and using that solution to soft wash a surface or object. FIG. 1 illustrates the general component parts of the proportioning system. The system is generally comprised of a series of tanks 52 (also referenced as first, second and third tank), a proportioning device 22, a pump 12 and a nozzle 20. As illustrated, series of tanks 52 are connected via a set of first hoses 24 (first, second and third hoses) to proportioning device 22. The hoses 24 are preferably top fed through the top of tanks 52 and extend downward to the base of the tanks. This prevents the pressure of the liquid in the tanks 52 from affecting the flow of the liquids through proportioning device 22. Series of tanks 52 are capable of being filled with a variety of different liquids. A cap 30 can optionally be provided at the top of each tank 52 to fill the tanks 52 with the desired liquid. Desirable liquids may include water, bleach, soap, etc. The proportioning device 22 is provided in order to provide the correct ratio of liquids into the soft washing mixture. It is preferable that soap is located in the central tank 52 and the outboard tanks 52 contain the bleach and the water. The suction provided by the downstream pump 12 provides a force that pulls the liquids from tanks 52 and through proportioning device 22. This force (negative pressure) in combination with the valves has an effect on the rate at which the liquids pass through proportioning device 22. The force provided to the outboard passageways 50 of the proportioning device 22 is equal, whereas the force upon the central passageway (i.e., the passageway that is positioned between the outboard passageways) is slightly greater based on the proximate location of the hose 24 to the exit of central passageway 50. Thus, it is preferable that soap is located in central tank 52 and fed to central passageway 50, such that bleach and water can be accurately proportioned on the outboard passageways 50 of proportioning device 22.

Each tank 52 is connected via the hoses 24 to the series of multi-chambered passageways 50. Multichambered passageways 50 include at least two valves and three chambers. Each passageway may be comprised of separate component pieces that are threaded together or one integral device. The valves and chambers provide a set ratio of liquid to the manifold 28, where the liquids mix to form the cleaning solution. Manifold 28 can be any chamber or area where liquids are capable of mixing together. From the manifold 28, the cleaning solution enters a hose 24 (second hose) leading to pump 12. Pump 12 can be any type of known pump 12 suitable for use in a soft washing system. For example, a positive displacement piston pump can be used to feed nozzle 20 while also providing suction to pull liquids from the tanks 52, through the proportioning device 22, and through hose 24 from manifold 28 of proportioning device 22. The nozzle 20 is attached to hose 66 and expels cleaning solution from nozzle 20. The liquid jet 16 of cleaning solution is used to clean surfaces and objects. The reader will appreciate that the user is able to clean a surface without stopping to re-mix a cleaning solution and the ratio of liquids provided is accurate. The present method allows the user to clean concurrently with mixing the cleaning solution. While the term “hose” is used throughout this description, “hose” could be any tube or line that allows liquid to pass through it under pressure.

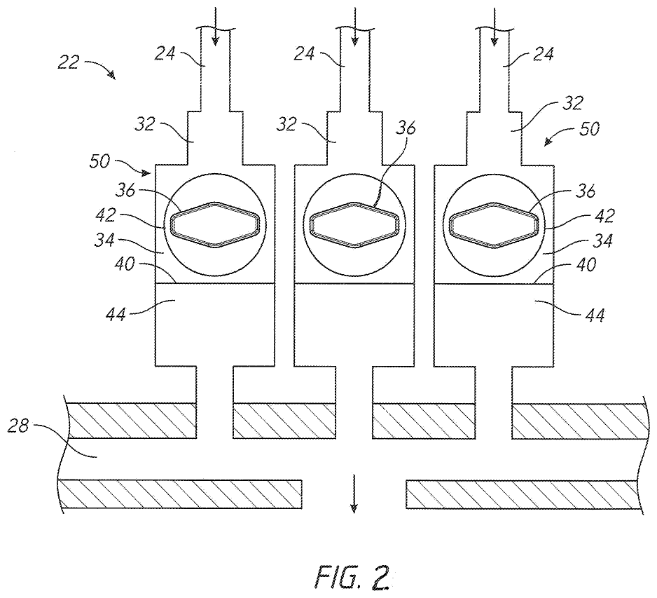

FIG. 2 is a schematic view, illustrating proportioning device 22 of the present method. Proportioning device 22 consists of at least two passageways 50. Passageways 50 are connected to a series of hoses 24, which provide a series of liquids to passageways 50. However, it is important to note that liquids could be provided by any known means. For example, liquids could be fed directly from liquid storage tanks 52 to passageways 50. Passageways 50 include a first chamber 32 (prior to a first valve), second chamber 34 (between first valve and second valve) and third chamber 44 (after second valve). Third chamber 44 is fluidly connected to manifold 28. Knob 36 is provided to set the ratio at which liquid passing through passageway 50 should be provided. Knob 36 is calibrated to give the user accurate information about the flow of liquid passing through the first valve. The liquids are mixed into cleaning solution as they enter manifold 28. The ratio of the pertinent liquids is controlled by the valves, further described below. Cleaning solution is pulled from manifold 28 into pump 12 which is positioned downstream of the proportioning device 22 (as shown in FIG. 1).

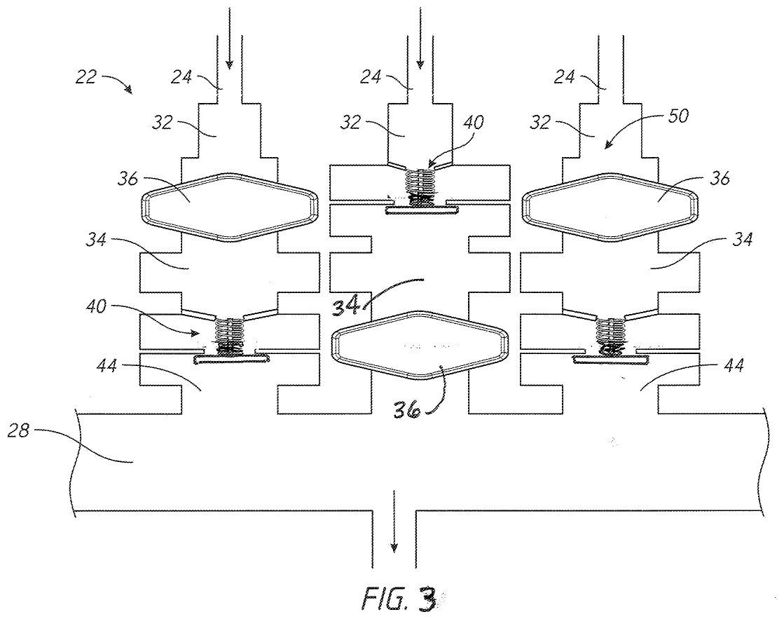

Another embodiment of the passageways 50 is shown in FIG. 3. Knob 36 is a handle and is staggered along passageways 50 such that the user can easily select the proper ratio of liquids without contacting another knob 36. In the central passageway 50 in the present embodiment, second valve 40 is located prior to first valve (not shown, but located beneath knob 36). The reader will appreciate that although the valves are labeled “first” and “second,” the label does not dictate the order in which the valves appear in the device. Thus, as is true for the central passageway 50 in the present embodiment, the second valve could be located prior to the first valve in any particular passageway (or vice versa).

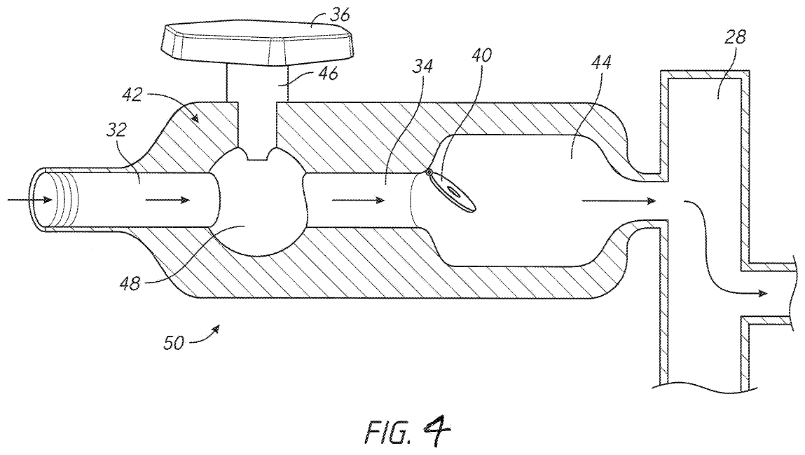

A cut-away view of passageway 50 is provided in FIG. 4. First valve 42 is preferably a valve designed to allow the user to select the ratio of liquid to mix into the cleaning solution, such as a control valve. Second valve 40 is preferably a valve (e.g., a check valve) which prevents the cleaning solution from re-entering the second chamber 34. FIG. 4 is a cut-away view of passageway 50, illustrating one embodiment. It is important to note that any known valve that can perform the function of allowing a user to select the amount or flow rate of liquid to pass through it can be utilized in the proportioning device 22. In this embodiment, first valve 42 is a ball valve provided to control the flow of liquid. As user turns knob 36, sphere 48 turns slowly allowing the liquid to flow through the open core of the ball or sphere 48. Liquid flows from first chamber 32 to second chamber 34 when first valve 42 is open. Second valve 40 is a swing check valve including a hinged disc. Disc can be biased downward (i.e., closed) by adding a spring or weight proximate the hinge. Again, in a closed position, second valve 40 prevents the backflow of liquid from third chamber 44 to second chamber 34. Liquid enters manifold 28, where cleaning solution is formed.

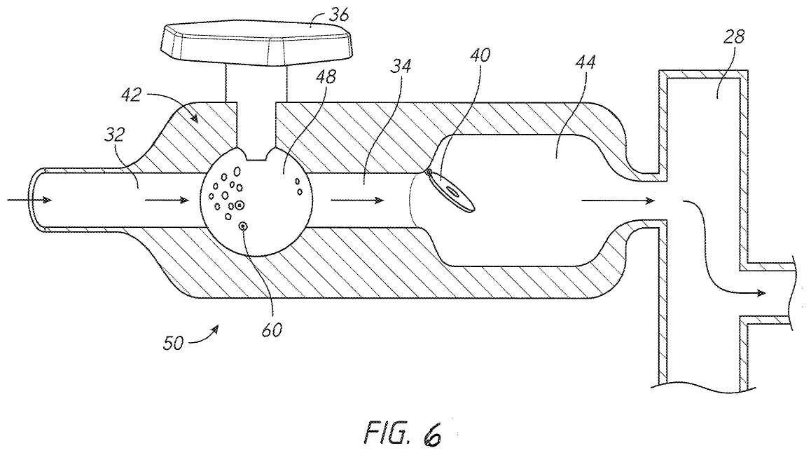

FIG. 6 shows another embodiment of the present invention. In this embodiment, first valve 42 is a specific type of ball valve. A typical ball valve, similar to the ball valve 42 shown in FIG. 4 that has a single, circular bore through sphere 48. However, in this embodiment shown in FIG. 6, sphere 48 includes multiple valve openings 60. As knob 36 is rotated clockwise, sphere 48 rotates and valve openings 60 are exposed. Those familiar with the art will realize that as more and more valve openings 60 are exposed to the flow, the flow will increase. This valve 42 can more accurately regulate flow due to the specific diameter and number of valve openings 60. Each exposed opening 60 increases the flow by a prescribed amount.

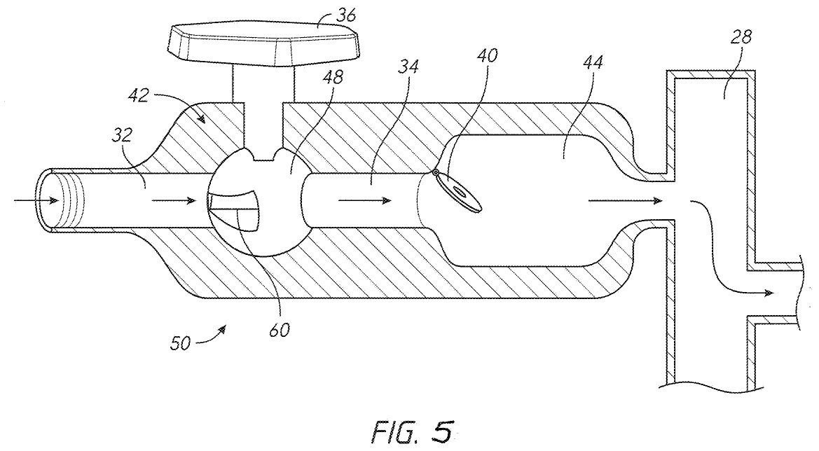

Similarly, FIG. 5 shows another embodiment of a ball valve. First valve 42 is a ball valve as in FIGS. 4 and 6. Preferably, sphere 48 includes valve opening 60. In this embodiment, valve opening 60 is has a trapezoidal profile. As with FIG. 6, this profile allows the flow rate to increase at a rate greater than if the profile was simply rectangular. As knob 36 is rotated clockwise, sphere rotates and valve openings 60 are exposed. Those familiar with the art will realize that that valve openings 60 in both FIGS. 5 and 6 allow the user to more accurately control the amount of liquid flowing through first valve 42.

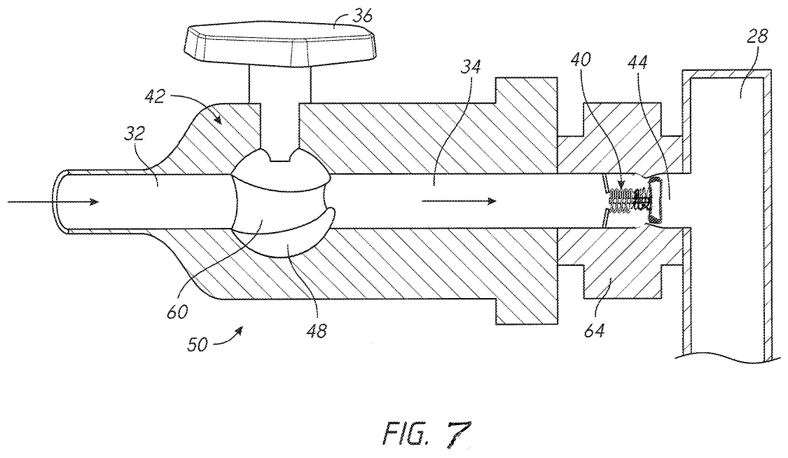

Similar to FIGS. 5 and 6, FIG. 7 shows another embodiment of a ball valve. First valve 42 is a ball valve having a sphere 48 that includes valve opening 60. In this embodiment, valve opening is a v-shaped groove along the outside of sphere 48. As illustrated, v-shaped opening 60 spans 180 degrees of sphere 48 as opposed to a typical ball valve which uses 90 degrees to open and close the valve. Those familiar with the art will note that by increasing the opening span, the increments of opening valve 42 are more precise. As sphere 48 is rotated by knob 36, opening 60 is exposed. Due to the v-shaped groove of opening 60, the water flow increases as valve 42 is opened. In the preferred embodiment, second valve 40 is a check valve. FIG. 7 illustrates second valve 40 having a closing member (the movable part that blocks the flow) is a disc which is spring-loaded to assist with keeping the valve shut. A series of arms extend away from outer wall of component 64 to support spring. When pump 12 (shown in FIG. 1) is activated, suction causes flow in the direction of arrows as the valve disc moves away from valve seat. Although suction causes flow to begin through second valve 40, first valve 42 can regulate the amount of liquid flow to manifold 28 thereby controlling the amount of liquid being mixed into the cleaning solution that is ultimately discharged.

Those familiar with the art will realize that it may be beneficial to have multiple check valves within passageway 50. The reader will note that passageway 50 can contain harsh chemicals such as bleach. In this case, it may be preferable to include a third valve as a second check valve. It is also possible to have second valve prior to first valve, wherein second valve 40 is a check valve, as illustrated in FIG. 7 and described above. Second valve 40 is located prior to first valve 42 in passageway 50. In cases where passageway 50 contains water, soap or another chemical which is not as harsh it may be preferable to include second valve 40 prior to first valve 42 in the center passageway 50 on proportioning device 22. This configuration allows the proportioning system to become more compact. This is shown in FIG. 3 where the central passageway 50 includes knob 36 not aligned horizontally with the other knobs 36. By placing the check valve 40 upstream of ball valve 42, passageways 50 can be closer together. This arrangement causes the liquid running through passageway 50 to remain within passageway 50 downstream of first valve 42. In the case of harsh chemicals such as bleach this is problematic. However, this passageway 50 can be used for soap or another mild chemical.

In general, soft washing allows the user to create mixtures with higher concentrations of soap, bleach, or other chemicals when compared with pressure or power washing. As those familiar with the art will know, the high pressure required in power washing does not allow for mixtures with less than 80 percent water. Proportioning device 22 coupled with a soft washing system allows the user to accurately mix the solution on the fly. This maximizes the cleaning power while minimizing cost (by not using or discarding more chemicals than necessary). In addition, as prior art methods rely on mixing the mixture prior to arriving on site or before the work is started, those methods cannot spray different surfaces. Typically, each surface requires a different concentration of solution. Thus, proportioning device 22 allows the user to spray one surface, adjust proportioning device 22, and then spray a different surface with a different concentrated solution without needing to manually remix a solution. In fact, this is done instantaneous and can also be done automatically. The proportioning device 22 preferably uses chemicals in order to hydro-clean surfaces. Some of the chemicals, such as bleach (chlorine-based), are highly basic which is caustic to certain materials. Therefore, the present invention uses materials that are resistant to caustic liquids. Some examples of materials used in for proportioning device 22 which are resistive to chemicals are polyvinyl chloride (“PVC”) and polypropylene. These are commonly understood materials used for such applications due to low cost and chemical resistance.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method of combining at least three liquids to form a solution mixture for soft washing a surface, comprising the steps of:
providing at least three tanks capable of separately containing said at least three liquids;
providing at least three first hoses each having a first end in fluid flow connection to a separate one of each of said at least three tanks;
providing a proportioning device connected to a second downstream end of each of said at least three first hoses, comprising;
at least three passageways each connected to a separate one of said at least three first hoses;
wherein said at least three passageways have a length, an axis and are at least three separate and distinct channels, wherein said length of said at least three passageways are equal, and said at least three passageways each including an entry end and an exit end;
a manifold fluidly connected to the exit end of each of said at least three passageways;
wherein said manifold is a hollow housing for receiving said at least three liquids direct from said at least three passageways simultaneously to form said solution mixture;
wherein each of said at least three passageways have a first valve and a second valve which separate said at least three passageways into a first chamber before said first valve, a second chamber between said first valve and said second valve and a third chamber after said second valve;
wherein said first valve is aligned on said axis of said at least three passageways with said second valve; and
wherein each of said chambers is an enclosed cavity within said at least three passageways of said proportioning device;
providing a second hose connected at a first, upstream end to said manifold;
providing a pump connected to a second, downstream end of said second hose, such that said pump is capable of causing a negative pressure within said manifold of said proportioning device to pull each of the three liquids from the at least three tanks and causing each of the at least three liquids to separately flow through the at least three passageways;
providing a nozzle for discharging the solution mixture in a pressurized sprayed jet stream;
providing a third hose connected to said pump and said nozzle;
calibrating said first valve of each of said at least three passageways according to a range of flow rates of each of the at least three liquids flowing through the at least three passageways; and
manually adjusting said first valve to a set position in each of said at least three passageways, whereby said set position of each of said first valves controls the flow rate of each of said at least three liquids, thereby controlling the proportion of each of said at least three liquids entering into said manifold according to a preset ratio determined by said set position of each of said first valves to form said solution mixture for discharge from the nozzle in the pressurized sprayed jet stream for application to the surface being soft washed.

2. A method of combining at least three liquids to form a solution mixture for soft washing a surface, comprising the steps of:
providing at least three tanks capable of separately containing said at least three liquids;
providing at least three first hoses each having a first end in fluid flow connection to a separate one of each of said at least three tanks;
providing a proportioning device including a fluid input end and a fluid discharge end, and the fluid input end connected to a second downstream end of each of said at least three first hoses, and the proportioning device further including a manifold adjacent the fluid discharge end for receiving said at least three liquids therein to form said solution mixture;
providing a second hose connected at a first, upstream end to the fluid discharge end of said proportioning device;
providing a pump connected to a second, downstream end of said second hose, and the pump being capable of creating a negative pressure within at least the said second hose and said proportioning device to pull each of the three liquids from the at least three tanks and causing each of the at least three liquids to flow through said proportioning device at a first flow rate;
providing a nozzle for discharging the solution mixture in a pressurized sprayed jet stream;
providing a third hose connected to said pump and said nozzle; and
controlling and adjusting the flow rate of at least one of said at least three liquids through said proportioning device higher or lower than the first flow rate to adjust the proportion of each of said at least three liquids in the formed solution mixture according to a desired ratio for discharge from the nozzle in the pressurized sprayed jet stream for application to the surface being soft washed.

3. The method as recited in claim 2 wherein the step of controlling and adjusting the flow rate of at least one of said at least three liquids includes the further step of:
manually controlling and adjusting the flow rate of at least one of said at least three liquids throughout a range of calibrated flow rates according to the desired ratio of said at least three liquids in the formed solution mixture.

4. The method as recited in claim 2 wherein the step of controlling and adjusting the flow rate of at least one of said at least three liquids includes the further step of:
manually controlling and adjusting the flow rate of at least two of the said at least three liquids throughout a range of calibrated flow rates according to the desired ratio of said at least three liquids in the formed solution mixture.
